(19) United States
(12) Patent Application Publication
(10) Pub. No.: US 2014/0331992 A1
(43) Pub. Date: Nov. 13, 2014

(54) PROCESS FOR RECOVERING SACCHARIDES FROM CELLULOSE HYDROLYSIS REACTION MIXTURE

(71) Applicants: BIOeCON International Holding N.V., Curacao (NL); Petróleo Brasileiro S.A. - PETROBRAS, Rio de Janeiro (BR)

(72) Inventors: Roman TSCHENTSCHER, Eindhoven (NL); Rafael MENEGASSI DE ALMEIDA, Waalre (NL); José Rafael Hernández CARUCCI, Eindhoven (NL); Johan VAN DEN BERGH, Dordrecht (NL); Jacob Adriaan MOULIJN, Den Haag (NL)

(21) Appl. No.: 14/339,549

(22) Filed: Jul. 24, 2014

Related U.S. Application Data
(63) Continuation of application No. PCT/EP2013/051591, filed on Jan. 28, 2013.

(30) Foreign Application Priority Data
Jan. 27, 2012 (EP) 12152966.3

(51) Int. Cl. C13K 13/00

(52) U.S. Cl. CPC C13K 13/007
USPC 127/34

(57) ABSTRACT

A method is disclosed for recovering saccharide monomers and/or oligomers from a reaction mixture. The reaction mixture may further comprise water and a molten salt hydrate.

The method may comprise adding an anti-solvent, whereby at least the saccharide oligomers are precipitated from the reaction mixture.

In an alternate embodiment molten salt hydrate is extracted from the reaction mixture using a suitable extractant.

### BACKGROUND OF THE INVENTION

1. Field of the Invention

The invention relates generally to the recovery of oligo- and monosaccharides from a reaction mixture resulting from a cellulose hydrolysis reaction, and more particularly to the recovery of oligo- and monosaccharides from a reaction medium comprising an inorganic molten salt hydrate.

2. Description of the Related Art

In view of environmental concerns, there is a need for platform chemicals and fuels from renewable resources such as biomass. Cellulose is the main constituent of lignocellulosic biomass (usually within 40-50 wt %), the other ones being hemicellulose, lignin, ashes and other extractables. Cellulose is a polymer of glucose (cellobiose being the repeating unit), and hemicellulose is a polymer of mostly pentoses (mainly xylose). Among others, glucose and xylose are considered desirable intermediate monosaccharides. Such monosaccharides can be converted to fuels and platform chemicals with known processes, such as fermentation to ethanol.

A particularly desirable way of obtaining glucose is by the hydrolysis of cellulose. U.S. Pat. No. 647,805 and U.S. Pat. No. 607,091 describe such hydrolysis processes, the first being a concentrated acid hydrolysis and the second a diluted acid hydrolysis. The diluted acid hydrolysis processes have lower yields, but do not need much further processing (acid removal) to separate or use glucose. On the other hand concentrated acid processes have higher yields but difficulties in sugar recovery and acid separation.

Cellulose has a recalcitrant nature that cannot be easily accessed to be hydrolyzed or derivatized. This can be circumvented by the fact that certain substances are capable to dissolve cellulose and hemicellulose. Heinze and coworkers provide an overview of the technology of dissolution of cellulose for derivatization (Heinze et al., 2001; El Seoud et al., 2005). Cellulose (and hemicellulose) are easily dissolved in some concentrated metal halides, like zinc halides (U.S. Pat. No. 257,607). Other dissolution (or at least swelling) agents are known, but not limited to, concentrated H₂SO₄, SO₂, concentrated HCl (>39 wt % HCl), H₃PO₄ (concentrated or in mixture with P₂O₅), concentrated nitric acid, lithium, calcium and magnesium halides, lithium chloride/N,N-dimethylacetamide, N-methylmorpholine-N-oxide, cadoxen (cadmium monoxide/ethylenediamine), chelating metal caustic swelling agents, organic cations ionic liquids such as 1-butyl-3-methylimidazolium chloride or hexafluorophosphate, LiOH or NaOH/urea solutions, ammonia, NH₃/NH₄SCN.

More particularly, solutions of sulfuric acid (from 60 to 77% H₂SO₄) and hydrochloric acid with at least 39 wt % of HCl or mixtures of HCl and other inorganic acids, can be used to dissolve cellulose and precipitate it later, as U.S. Pat. No. 1,082,490 and U.S. Pat. No. 1,141,510 and U.S. Pat. No. 1,218,954 and U.S. Pat. No. 1,242,030 teach. This precipitation or coagulation is employed to obtain cellulose with different properties or derivatize to compounds such as cellulose acetate.

Dissolution of cellulose (and hemicellulose) is also used to enhance the yields in the hydrolysis to monosaccharides. U.S. Pat. No. 1,544,149 teaches the use of concentrated HCl (with at least 39 wt %) to obtain sugars from biomass (saw dust). The concentrated HCl hydrolyses and leaches sugars to the acid solution. This acid and sugar solution is further contacted with different batches of biomass, enriching the sugar content of the hydrolysate solution to more than 50 wt %. Similarly, H₂SO₄ can also be used, as U.S. Pat. No. 1,917,539 and U.S. Pat. No. 1,964,646 teach. Other published applications such as US 2010/0024810 teach the use of a mixture of concentrated phosphoric and sulphuric acid to effect dissolution and finish the hydrolysis of cellulose and hemicellulose upon dilution. No method of separation of glucose and xylose from the acidic solution is given.

Other processes take advantage of the swelling or dissolution agents to hydrolyze cellulose. U.S. Pat. No. 4,018,620 teaches the use of a mixture of CaCl₂ and HCl to convert lignocellulose to monosaccharides. Similarly, U.S. Pat. No. 4,713,118 teaches the use of halides of Li, Mg and Ca with at least 1 molar added HCl to effect dissolution and hydrolysis of cellulose.

U.S. Pat. No. 4,058,411 teaches the use of a H₃PO₄ swelling/dissolution step, with further cellulose precipitation to recover the acid. Cellulose is precipitated by the use of tetrahydrofuran, which can dissolve the phosphoric acid but not the cellulose. The precipitated cellulose is then more easily hydrolyzed using acids or enzymes.

U.S. Pat. No. 4,265,675 teaches the use of a chelating metal/caustics swelling mixture to dissolve cellulose, precipitate it and further hydrolyze the cellulose with acid or enzyme. Similarly, U.S. Pat. No. 4,174,976 teaches the use of another dissolution agent, cadoxen, with further precipitation of cellulose, and acid or enzymatic hydrolysis.

U.S. Pat. No. 4,266,981 and U.S. Pat. No. 4,281,063 use the same expedient of dissolution and further precipitation of cellulose for enzymatic hydrolysis with recovery of the solvent, but with an initial step of hemicellulose hydrolysis using dilute acid.

U.S. Pat. No. 4,452,640 of Chen teaches the use of ZnCl₂ solution (preferably from 65 to 75 wt %) to effect dissolution of cellulose and a first partial hydrolysis to oligomers (or cellodextrins), and a later hydrolysis step, diluting the solution with a water or acidic (HCl) solution to dilute ZnCl₂ and effect final hydrolysis to glucose, with yields near and above 90%. Chen teaches that glucose was significantly degraded in the presence of concentrated acidic ZnCl₂ medium, therefore a 2-step process is necessary. Chen teaches that it was not possible to reach high yields of glucose in concentrated ZnCl₂, making dilution of the solution mandatory. The authors used temperatures in the range of 70 to 180° C., preferably from 100 to 145° C. The authors employed a glucose analyzer to analyze the hydrolysates, and therefore analyzed just the amount of glucose in the products and not dimers and oligomers.

The same inventors claim in the later U.S. Pat. No. 4,525,218 that the products of first incomplete hydrolysis in the dissolution media (cellodextrins) should be further separated completely from the ZnCl₂ acidic dissolution media before formation of any monomer (glucose), by precipitation of the oligomers using an (anti)solvent such as acetone, ether, methanol or ethanol.

A general problem in such processes is the separation of the concentrated acid and/or dissolution media from the final desired monosaccharides. One can simply avoid the problem by stopping the hydrolysis at larger intermediates (oligomers), as described in U.S. Pat. No. 4,525,218 and U.S. Pat. No. 4,452,640, or simply precipitate the cellulose to effect diluted or enzymatic hydrolysis The precipitated cellulose is easily separated, so that the solvent does not interfere with further process steps such as fermentation to ethanol. Or one can try to separate the final desired monosaccharides from the acidic solution.

It is known for a long time that glucose exhibits a low solubility at ambient temperature in methanol and ethanol (U.S. Pat. No. 247,957 and U.S. Pat. No. 247,958) and the addition of such solvents to glucose solutions can effect its precipitation.

The ability of some solvents to precipitate monosaccharides and also disaccharides is used in the sugar industry. U.S. Pat. No. 1,776,819 teaches the use of an acetic acid and alkyl acetate (or alcohol) solution to precipitate saccharose from molasses. U.S. Pat. No. 2,943,004 teaches that saccharose can be extracted with alcohols at higher temperatures and precipitated upon cooling. U.S. Pat. No. 2,000,202 teaches a process of recovering saccharose from exhausted molasses by using a first acids removal step (with an organic non-sugar solvent such as ethyl acetate plus 95% EtOH and H₂SO₄), followed by the sugar removal step (using 80 to 90% EtOH) and a final precipitation of sugar by vaporization of EtOH. This patent shows that a saccharide poor solvent such as EtOH can be rendered a sugar solvent by the addition of water.

In U.S. Pat. No. 1,863,654 wood is hydrolyzed with HCl, which is to a large extent removed from the glucose by spray-drying. An important amount of HCl still remains in the solid, which is extracted with a mixture of 95 wt % EtOH and benzene. Benzene further depresses the solubility of sugar in alcohol and increases the HCl absorption ability.

U.S. Pat. No. 1,917,539 teaches that products of cellulose hydrolysis can be precipitated by addition of 50 parts of dimethyl ether to 60 parts of a hydrolysate (obtained 10 parts of cellulose, 50 parts of concentrated H₂SO₄).

U.S. Pat. No. 1,964,646 teaches that products of cellulose hydrolysis can be precipitated by the addition of acetone to the hydrolysate. Acetone is a solvent for H₂SO₄ but not for hydrolysis products. The patent cites the use of two parts of acid with 65 to 80 wt % H₂SO₄ to each part of wood, and the final addition of 2 parts of acetone to each part of acid.

U.S. Pat. No. 2,450,717 teaches the use of EtOH to precipitate glucose from concentrated solutions.

U.S. Pat. No. 2,465,347 teaches the hydrolysis of biomass by hot water liquefaction. After hydrolysis, acetone, ethers, aliphatic alcohols and mixtures, can be added from 2 to 7 times, preferably 4 times the hydrolysate to precipitate C5 and C6 sugars (pentoses and hexoses).

U.S. Pat. No. 4,772,334 teaches the hydrolysis of gum arabic to obtain the monosaccharide rhamnose. Rhamnose is removed by the hydrolysate by 5 to 20 parts of a polar solvent such as acetone, acetonitrile, ethanol, isopropanol.

Other monosaccharides such as fructose can be recovered from a mixture of saccharides by the precipitation upon contact with organic solvents. U.S. Pat. No. 4,643,773 and U.S. Pat. No. 4,724,006 teach the concentration of a fructose and glucose solution to not more than 15% water and mixing such solution with mixtures of ethanol and isopropanol to effect the precipitation of mainly pure fructose.

Pentoses can also be recovered independently from hexoses in the hydrolysis of biomass. The hemicellulose fraction can be hydrolyzed at a lower severity than cellulose, yielding mainly xylose among other pentoses and some hexoses. U.S. Pat. No. 3,784,408 teaches the hydrolysis of the hemicellulose portion of biomass, drying to 5 to 15% final water content and further precipitation of mainly pentoses by mixing with methanol. At least 0.5 parts of methanol are necessary for each part of hydrolysate. U.S. Pat. No. 5,340,403 also shows that the amount of water in the hydrolysate should be lower than 40%, preferably from 20 to 40%, otherwise no significant amounts of xylose are precipitated upon addition of ethanol to the mixture. U.S. Pat. No. 3,639,171 teaches that xylose can be extracted first (for example from the black liquor from pulping of biomass) by isopropanol at temperatures not higher than 60° C., the solvent recovered by phase separation at lower temperature (5° C.) and the xylose precipitated by the addition of ethanol.

In general it is necessary to have a concentrated solution (less water) to effect the precipitation of saccharides when contacting with an organic solvent. U.S. Pat. No. 6,802,977 teaches the contact of concentrated saccharide solutions (such as soy molasses) with solvents such as ethanol to recover precipitated saccharides.

Other ways of recovering the saccharides by the use of solvents, not involving precipitation of those saccharides, are known in the art, such as:

U.S. Pat. No. 3,173,908 teaches a method of fractionating aqueous polysaccharides with different degrees of polymerization by contacting the liquid with a water miscible organic phase in a liquid-liquid extraction contacting device. The so called water-miscible organic solvents of the invention include cyclic ethers such as dioxane and tetrahydrofuran, ketones such as acetone, propanone and the like and lower alkanols with 1 to 4 C atoms, such as methanol, ethanol, n-propanol, isopropanol, t-butanol. Higher degree of polymerization saccharides remain in the bottom aqueous phase and lower degree of polymerization saccharides are recovered in the light, upper phase. No saccharides are precipitated in the contacting device.

U.S. Pat. No. 2,022,093 and U.S. Pat. No. 2,022,824 apply a similar concept of concentrating saccharides in a biphasic system, using respectively the use of isopropanol to recover non-sugars, and the use of a mix of ethanol and isopropanol to concentrate the non-saccharides in the isopropanol rich phase.

The same inventor teaches later, in U.S. Pat. No. 2,109,503, that a number of saccharides non-solvents can be turned into solvents by applying a pressure of NH₃. This is used to extract those saccharides from an aqueous solution. The phases are separated, and the saccharides are subsequently precipitated by lowering the ammonia pressure, which renders the saccharides insoluble. U.S. Pat. No. 2,829,985 also teaches the use of ammonia mixed with organic solvents to recover the disaccharide sucrose, which is subsequently precipitated when the ammonia is removed. The disclosed organic solvents are alkanols, diols, ketones, formamide, dimethyl formamide, mixtures of these solvents, or at least one of said solvents mixed with an aromatic hydrocarbon.

The previously cited hydrolysis and saccharides recovery technologies use the precipitation of saccharides or polysaccharides as a way of recovering the hydrolysis products from the hydrolysate. Other possible ways known in the art of separating the saccharides is by recovery of the acid from the hydrolysate solution, leaving the sugar in the aqueous solution.

U.S. Pat. No. 4,237,110 teaches the contact of a HCl cellulose hydrolysate with C5 to C9 alkanols, extracting the HCl and leaving the saccharides in the aqueous solution. The HCl can then be recovered to be used again in the hydrolysis step.

U.S. Pat. No. 4,608,245 teaches the use of C4 to C7 alkanols to extract H₂SO₄ from a hydrolysate, remaining the saccharides in the aqueous solution. The alkanol —H₂SO₄ solution is further contacted with a second solvent such as benzene, toluene, carbon tetrachloride, chloroform and ether, in order to have 2 phases, one rich in the alkanol and the second solvent, and the other rich in H₂SO₄. The two solvents and the acid can thus be separated and reused in the process.

U.S. Pat. No. 6,007,636 teaches the use of a solvent to effect the precipitation of depolymerized cellulose and hemicellulose (mixture of saccharides such as glucose and xylose and oligomers of different degrees of polymerization) from an aqueous acidic hydrolysate. The hydrolysate should contain from 10 to 40 wt % of water. The solvent comes from a previous counterflow extraction step used to remove most of the acidic mixture from the precipitated saccharides. The acid can be further removed from the acidic liquor by another solvent, and the water insoluble solids can be separated from the precipitated saccharides by addition of water. Claimed dissolution media or acids to effect hydrolysis are HCl, sulfuric acid, methanesulfonic acid, inorganic sulfates and halides such as ZnCl₂ and combinations thereof. No specific precipitation solvent is claimed but acetone and ethanol are used in the examples.

U.S. Pat. No. 6,258,175, from the same inventor, teaches the use of concentrated sulfuric acid as hydrolysis medium, and ethanol to effect the precipitation of all the resulting saccharides. Ethanol and concentrated sulfuric acid are separated by distillation and returned to the precipitation and hydrolysis steps. In one of the embodiments, glucose formed in the precipitation step is fermented to ethanol. The conversion of cellulose to glucose is not complete.

Along with the acids from hydrolysates as in the previously discussed patents, it is also possible to recover other dissolution media, such as metal halides used for cellulose dissolution, from the hydrolysate. Ways of recovering metal salts from aqueous solutions are known in the art, known as the field of hydrometallurgy. Known means of recovering salts are solvent extractions, ion exchange, electrolysis and precipitation.

U.S. Pat. No. 4,631,176 and U.S. Pat. No. 3,441,372 and U.S. Pat. No. 3,446,720 teach ways of recovering ZnCl₂ from aqueous solutions. Zinc chloride can be extracted by organic extractants known in the art, such as tributyl phosphate, primary, secondary or tertiary amines and quaternary amine salts, the loaded extractant being stripped with organic stripping agents such as ethylene glycol, propylene glycol, furfural.

U.S. Pat. No. 7,407,643 teaches the concentration of zinc chloride by adding an organic polar solvent having olefinically unsaturated nitrile such as trans-3-pentenenitrile.

U.S. Pat. Nos. 4,257,914 and 4,136,056 and 4,081,400 teach the recovery of molten zinc chloride by incineration and condensation of the vaporized zinc halide.

U.S. Pat. No. 4,105,747 teaches the separation of metal chlorides such as zinc chloride from an aqueous solution by dissolution in an organic solvent and contact with molecular sieves of pore sizes sufficient to exclude metal chlorides and the solvent molecules but not water.

U.S. Pat. Nos. 3,287,086 and 2,285,573 teach that metal halides can complex reversibly with ammonia and precipitate, and all the complex compounds can be converted back to metal halides and ammonia by heating.

Other patents teach ways of avoiding using solvents to remove the acid from hydrolysate.

U.S. Pat. No. 5,868,851 teaches that with hydrolysates containing certain compositions of a H₂SO₄ acid and glucose, it is possible to form a different glucose precipitate phase containing virtually all the glucose. The times to effect precipitation are of at least 5 h.

US Patent 2010/0126501 avoids the use of classical soluble acids in hydrolysis by the use of heteropoly acids that form a pseudo-molten state upon addition of some water. Finished the hydrolysis, water is removed and the acid and saccharides precipitate. Upon addition of ethanol or other suitable solvent, only the heteropoly acid is solubilized, saccharide being recovered.

Other patents teach ways of separating biomass in its constituents in order to further process them separately.

US Patent Application 2010/0196967 teaches the use of two ionic liquids to effect the fractionation of cellulose and lignin. A first ionic liquid dissolves de biomass, being added a second ionic liquid that is immiscible with the first ionic liquid but cannot dissolve cellulose. The cellulose is separated as a precipitate and the lignin recovered by acidification of the ionic liquid until it precipitates. The cellulose can be further hydrolyzed by acids to yield fermentable glucose.

Other ways of fractionating biomass in its constituents are known in the art and most involve the hydrolysis of hemicellulose as a first step. Dilute acid hydrolysis, steam explosion, ammonia fiber explosion (AFEX), liquid hot water treatment, organosolv pulping (example, hot ethanol to dissolve lignin), alkaline hydrolysis, use of ionic liquids are known processes in the art ^{1 2}. They are usually used to make cellulose more easily depolymerized in enzymatic hydrolysis. ¹Biomass and Bioenergy, 28(4), 384-410. doi:10.1016/j.biombioe.2004.09.002²Hamelinck, C., van Hooijdonk, G., & Faaij, A. (2005). Ethanol from lignocellulosic biomass: Techno-economic performance in short-, middle- and long-term. Biomass and Bioenergy, 28(4), 384-410. doi:10.1016/j.biombioe.2004.09.002

US Patent Application 2009/0229599 claims the use of a cellulose dissolution step using polyphosphoric acid, use of a solvent to lignin dissolution, cellulose and hemicellulose precipitation and later solvent recovery by means of steam, vacuum or combination of these. The amorphous cellulose and hemicellulose can be subsequently more easily hydrolyzed. Claimed solvents to effect the delignification and precipitation of cellulose and hemicellulose are ethanol with 80% water or CO₂, SO₂, O₃, and mixtures.

US Patent Application 2010/0170504 of the same inventor claims the use of a cellulose dissolution step using polyphosphoric acid, a precipitation step using acetone as solvent, a second solvent to dissolve lignin and a third solvent to precipitate cellulose and recover hemicellulose saccharides. Several steps of recovery of solvents are necessary for each solvent used, and an additional cellulose hydrolysis step is necessary.

Several ways to convert the cellulose and hemicellulose portions of biomass to its constituent sugars are known in the art. Degradation of monosaccharides during acid hydrolysis, longer times of enzymatic hydrolysis, the necessity of several separating steps when solvents are used, or the need of different solvents for each portion of biomass are all problems existing in the field of biomass conversion, and the multiplicity of existing alternatives further point to the fact that better solutions are necessary.

U.S. Patent Application Publication 2011/060148 discloses a process for converting cellulose to monosaccharides in a molten salt hydrate reaction medium. The monosaccharides are converted in situ to less polar platform chemicals, such as isosorbide. The platform chemicals can be removed from the reaction medium by extraction. This reference does not disclose a process for removing the cellulose hydrolysis products from the reaction medium.

Thus, there is a particular need for a method for isolating oligo- and monosaccharides from a reaction medium comprising a molten salt hydrate.

### BRIEF SUMMARY OF THE INVENTION

The present invention addresses these problems by providing a method for isolating monosaccharides and/or saccharide oligomers from a solution further comprising water and a molten salt hydrate, said method comprising the step of adding to the solution an effective amount of an anti-solvent selected from the group consisting of ketones having four or more carbon atoms; ethers; alkanenitriles; and mixtures thereof, thereby precipitating at least the saccharide oligomers from the solution.

Another aspect of the invention comprises a method for recovering the molten salt hydrate by extraction with a suitable extractant, such as tributyl phosphate or an ether.

### BRIEF DESCRIPTION OF THE DRAWINGS

The features and advantages of the invention will be appreciated upon reference to the following drawings, in which:

FIG. 1 is a schematic representation of a first embodiment of the process of the invention

FIG. 2 is a schematic representation of a first embodiment of the process of the invention

FIG. 3 is a graph showing the percentage of precipitation of cellobiose and glucose as a function of the addition of anti-solvent according to Example 13.

### DETAILED DESCRIPTION OF THE INVENTION

The following is a detailed description of the invention.

The present invention relates to a process for the recovery of saccharides from a reaction medium comprising a molten salt hydrate. In a preferred embodiment the process of the invention is integrated with a process for the hydrolysis of cellulose and/or hemicellulose in the molten salt hydrate reaction medium.

The term “saccharides” as used herein refers to water-soluble oligosaccharides and monosaccharides. The term “oligosaccharides” as used herein water-soluble depolymerization reaction products of polysaccharides, such as cellulose, hemicellulose, or starch, in particular disaccharides, trisaccharides, and tetrasaccharides.

More specifically, the invention relates to the recovery of saccharides from the reaction mixture resulting from the conversion of cellulose and/or hemicellulose. In a preferred embodiment, the main products are monosaccharides such as glucose and xylose. In a particular embodiment, the main products are disaccharides such as cellobiose and/or xylobiose.

It was discovered by the inventors that the hydrolysis of polysaccharides dissolved in molten salt hydrate media, under the conditions described hereinbelow, yields an equilibrium mixture, i.e., a mixture that reaches an invariant composition after certain time. In the hydrolysis of cellulose, with the preferred amount of acidified salt hydrate medium, a mixture of mainly glucose, cellobiose (and some higher oligomers) and a small amount of 1,6-anhydroglucose results. In the hydrolysis of hemicellulose, a mixture of mainly xylose and dimers results. Such mixture of invariant composition will be referred to herein as equilibrium hydrolysate. Surprisingly, it was discovered that the same final composition is obtained if the starting material is, glucose, cellobiose or 1,6-anhydroglucose instead of cellulose. Different from what has been reported in the prior art, the amount of degradation, such as formation of 5-hydroxymethylfurfural, was negligible in the claimed conditions.

It was discovered that, besides glucose and a minor amount of 1,6-anhydroglucose, only significant amounts of dimers are formed in the equilibrium hydrolysate when the mass ratio of acidic salt hydrate medium to cellulose is greater than 12. At higher concentrations of cellulose also oligomers of more than 2 anhydroglucose units, such as cellotriose and cellotetrose are formed.

It was further discovered by the applicants that the disaccharides portion can be separated from the monosaccharide portion of hydrolysate by the use of an anti-solvent, i.e., a solvent that can dissolve the molten salt hydrate and the acid, but not the disaccharide. It was additionally discovered that by changing the amount of anti-solvent used, it was possible to precipitate mainly the disaccharides (and higher oligomers, if present) and only a lower amount of the monosaccharides.

It was further discovered by the inventors that the recovered disaccharides can be hydrolyzed by an additional hydrolysis step or, in a preferred embodiment, by recycle of the disaccharides to the initial cellulose hydrolysis step. It was also further discovered that monosaccharides precipitated in the first anti-solvent step could be sent back to the hydrolysis step without significant degradation.

It was discovered that by effecting such recycle of disaccharides, a higher amount of oligosaccharides per amount of added anti-solvent is precipitated, lowering the amount of anti-solvent needed. It was further discovered that the presence of the molten salt hydrate, compared to a purely aqueous system, lowers the solubility of disaccharides in the molten salt hydrate plus anti-solvent phase, enhancing the recovery of the disaccharide.

Besides cellulose and hemicellulose, starch is also a possible feedstock. Cellulose and starch are polymers of glucose units, linked respectively by β glucosidic bonds and a bonds. Hemicelluloses are polymers of mainly pentoses like xylose, mannose, galactose, rhamnose, and arabinose and with a smaller amount of hexoses, including glucose.

Preferably, hemicelluloses are removed from the lignocellulosic material prior to the hydrolysis reaction. The separation of hemicellulose from biomass is easily effected with hot water treatment or aqueous phase diluted acid hydrolysis or other methods known in the art. In this way, besides lignin, remaining lignocellulose yields mainly hexoses upon hydrolysis.

In another embodiment of the invention both hemicellulose and lignin can be removed by the ways known in the art previously to the contact of the remaining cellulose with the molten salt hydrate solution.

In another embodiment of the invention, the hemicelluloses are separated from the lignocellulosic material by the contact with a less concentrated molten salt halide solution, such as 10 to 50 wt %. In this condition, only hemicellulose is dissolved and cellulose remains as a solid with lignin. In a preferred embodiment, hemicellulose is converted separately from the cellulose. In a particular embodiment, hemicellulose is converted together with cellulose.

Examples of lignocellulosic materials can be wood pulp, bagasse (in particular sugar cane bagasse), sawdust, cotton linter, stover, corn, straw, grasses, guar, paper, forestry residues, sugar beet pulp, agriculture residues, algae, among others, not limiting the scope of invention to a particular lignocellulosic material, being useful a material having at least 20 wt %, preferably 40 wt % of cellulose.

Lignocellulosic material is preferably pre-treated to ensure a good contact with the molten salt hydrate medium. Comminution can be effected by cutting, crushing, grinding and/or rasping. Preferably, crushers are used followed by grinders. In one of the preferred embodiments, comminution of the lignocellulosic biomass material is effected in the first step, before the contact with the molten salt hydrate medium. In other preferred embodiment, the comminution is effected together with the contact with the molten salt hydrate medium.

The lignocellulosic biomass also has some other compounds that can be recovered prior to the contact with the molten salt hydrate medium. Extractables such as proteins can be recovered by treatment with hot water. Ashes and other salts can be partially removed by the same hot water treatment, or slightly acidic or basic aqueous solution. Long chain carboxylic acids, or waxes, can also be recovered prior to or after the hydrolysis, by using a suitable organic solvent.

Removing these materials in a pretreatment is a preferred embodiment of the invention, as such compounds can accumulate in the recycle of the molten salt hydrate medium, and interfere with the hydrolysis and dissolution. More preferably, there is also a molten salt hydrate recovery step. The molten salt recovery step can be simply the recycle of the molten salt. More preferably the recovery step also involves the control of the amount of water in the molten salt hydrate, in order to keep the amount of water as a constant in the continuous process. In another preferred embodiment the molten salt hydrate recovery step also involves the removal of some of the organic materials that were not removed in the pretreatment and could interfere in the process. Several ways of recovery of such compounds are known in the art, such as ultrafiltration, dialysis, electrodialysis, adsorption, extraction. In the case of ZnCl₂, which is the preferred molten salt hydrate, besides the previously mentioned ways of removal of contaminants, the whole ZnCl₂ can be recovered. It can be extracted by organic extractants such as tributyl phosphate, primary, secondary or tertiary amines and quaternary amine salts, polar solvent having olefinically unsaturated nitrile such as trans-3-pentenenitrile, by complexation with ammonia, or other ways known in the art.

According to the invention, the water content of the mixture of the molten salt hydrate medium and the lignocellulosic biomass material should result in a total water content in the mixture such that the cellulose material is soluble in the molten salt hydrate medium. Thus, it can be necessary to feed a molten salt hydrate medium with less water in case the material has significant water content. In another preferred embodiment, the water content of the cellulose material is lowered before contact with the salt hydrate medium to avoid unwanted dilution.

Preferably, molten salt hydrate media for the cellulose and hemicellulose dissolution have at least 40 wt % of ZnCl₂, more preferably 60 wt % of ZnCl₂. The preferable salt content in salt hydrate media for a dry biomass material cellulose dissolution is within the range of 55 to 85 wt %. The salt content can be increased to compensate for water present in non-dried lignocellulosic material with high water content, using a mass balance calculation known to the person skilled in the art. Higher than 85 wt % salt contents in the ZnCl₂ media are less desirable, as such higher salt content can be higher than the saturation concentration under the reaction conditions and lead to high viscosities or precipitation of ZnCl₂ in the salt medium.

Although 70 wt % ZnCl₂ is the preferred molten salt hydrate for the cellulose dissolution, other molten salt hydrate media are possible to use alone or in combination with ZnCl₂, such as other zinc halides (bromide, iodide), or other halides known to dissolve or swell cellulose, such as CaCl₂ and LiCl.

In the embodiment where hemicellulose is dissolved and hydrolyzed separately, before the hydrolysis of cellulose, the preferred molten salt hydrate has at least 10 wt % of ZnCl₂, more preferably 30 to 50 wt % of ZnCl₂, in such a way that just hemicellulose is dissolved, and cellulose is not dissolved.

For dissolving the cellulose component, the ratio of molten salt hydrate medium to biomass is preferably from 0.5 to 50 wt/wt, more preferably from 10 to 20 wt/wt. Low ratios result in a too high viscosity, incomplete contact of the molten salt hydrate and the biomass and the formation of oligomers besides the dimers, but too high ratios demand a high rate of recycle of the molten salt hydrate salt and lower recovery of the saccharides. It was further found experimentally that to avoid the presence of higher oligomers in the hydrolysate, a ratio of salt hydrate to biomass should be at least 10 wt/wt.

Preferably, the molten salt hydrate medium to biomass ratio avoids the formation of oligomers higher than dimers, and keeps the viscosity and mixing within reasonable limits. By mixing it is understood that it is possible to intimately contact biomass with the acidic molten salt hydrate medium. Lignocellulosic biomass density typically ranges from 75 to 200 kg/m3, whereas the density of molten salt hydrate such as ZnCl₂ 70 wt % solution is almost 2000 kg/m3. Assuming a biomass density of 100 kg/m3 and assuming further that, for proper mixing biomass and the molten salt hydrate should be mixed in about equal volumes, the weight ratio of ZnCl₂ molten salt hydrate to biomass would be 20 wt/wt.

Prior to contacting with biomass, the molten salt hydrate temperature can be heated to a temperature which is higher than the desired temperature in the hydrolysis step. Alternatively, the mixture of lignocellulosic biomass and molten salt hydrate can be heated after mixing. Means of heat transfer known in the art can be utilized for obtaining the conditions required for the several modes of the present invention. In any event, the resulting temperature should be the one desired in the hydrolysis step. The hydrolysis step can be effected with only cellulose, if the lignocellulose was previously separated from the hemicellulose portion by the pretreatments known in the art. In this case hemicellulose can be hydrolyzed separately in a less concentrated ZnCl₂ solution. Alternatively the cellulose and hemicellulose portions can be hydrolyzed together.

In a hydrolysis step of the present invention addition of a Brønstedt acid is advantageous. Suitable examples include inorganic acids, more preferably hydrochloric acid. Other mineral acids can be used such as hydrofluoric, sulfuric, phosphoric, and the like, or organic acids such as formic or acetic acids. Hydrochloric acid is nonetheless the preferred acid, as it can be easily removed from the molten salt hydrate medium by flash, distillation or stripping with nitrogen or other suitable means known in the art. Suitable acid molality (mol/1000 g) of molten salt hydrate and acid mixture is higher than 0.01 molal and lower than 2.0 molal, preferably from 0.1 to 0.4 molal. Higher concentrations of acid can enhance saccharides degradation to undesirable compounds. In general, acidity in the upper end of the range is preferred for the hydrolysis of cellulose by itself; a somewhat lower acidity is preferred when hemicellulose and cellulose are hydrolyzed together, and a still lower acidity for the hydrolysis of hemicellulose by itself.

The hydrolysis temperature is selected to obtain a high hydrolysis rate, but low degradation of glucose to undesired compounds. In practice, preferred temperatures are higher than 20° C. and lower than 120° C., more preferably higher than 50° C. and lower than 90° C. To ensure desired temperature in the hydrolysis step, added gases to the reaction system can be used as heat transfer media. Preferably such gases are substantially oxygen-free. The hydrolysis of hemicellulose requires a lower temperature than the hydrolysis of cellulose.

The hydrolysis time, or residence time in the apparatus where the lignocellulosic material and molten salt hydrate and mineral acid are contacted is selected to provide full hydrolysis of cellulose (and hemicellulose, if present). In practice, the residence time should be from 3 to 300 minutes (equivalent to a LHSV of 0.2 to 20 h⁻¹), preferably from 30 to 60 minutes (corresponding to a LHSV of 1 to 2 h⁻¹).

The pressure in the hydrolysis step should be high enough to keep water and the acid in the liquid phase. In the conditions practical to the invention, less than 10 bar, preferably less than 2 bar total pressure is enough to have the desired effect.

Equipments to effect the hydrolysis can be batch reactors, continuous stirred tank reactors (CSTR) or a sequence of 2 or more CSTRs, continuous tubular reactors, fluidized bed reactors (suspended biomass particles whose cellulose is being dissolved), trickle bed reactors, screw reactors, double screw reactors, rotating reactors with or without ball milling, leaching, belt (De Smet) diffusers, a combination of them or any suitable mean of contact of the phases. In the case of batch reactors, several parallel reactors can be used, so that the subsequent homogeneous-phase process steps can be kept continuous. The whole process sequence can also be done in batch mode, but a continuous process is preferred. The advantages of a continuous process over a batch process are well known to one skilled in the art.

The dissolution and hydrolysis convert the hydrolysable material (cellulose and/or hemicellulose or starch) to saccharides. After the hemicellulose dissolution and hydrolysis step it can be fully separated from the lignocellulose. After the cellulose hydrolysis step the lignin can be fully separated from the molten salt hydrate and saccharide solution. Suitable means to separate the insoluble lignin from the molten salt hydrate and sugar solution are filtration, centrifugation, decantation, use of hydrocyclones, settling, gas flotation, addition of an organic phase to which lignin would selectively interface, or a combination of these methods. A preferred method is centrifugation or hydrocyclones, with additional filtration to prevent any solid from being sent to further process steps. Lignin is preferably further washed to remove salt still present in the solid cake, prior to further use. Lignin can be used as a heat source to the process and to produce chemicals needed in production of derivatives of glucose produced in the process, such as hydrogen when producing sorbitol.

It is also possible to decouple dissolution and hydrolysis. It is possible to dissolve hemicellulose and/or cellulose and separate the molten salt hydrate and dissolved polysaccharides from the remaining solid with a minimal amount of formation of disaccharides and monosaccharides. A partial hydrolysis of part of the polysaccharides chains is sufficient to significantly lower the viscosity of the molten salt hydrate polysaccharides solution, and effect the lignin separation.

The hemicellulose can be dissolved and separated from the lignocellulose without the hydrolysis of cellulose.

The cellulose can be dissolved and separated from the lignin before the total conversion to equilibrium hydrolysate.

In a preferred embodiment of the invention the lignocellulose/molten salt hydrate mixture is subjected to two steps. In the first step a solution having relatively low viscosity solution is obtained after hydrolysis, allowing lignin to be recovered easily using means known in the art. In the second step the hydrolysate of the first step, free of lignin, and optionally mixed with recycled disaccharides, is hydrolyzed until the equilibrium composition is reached.

In the embodiment where the cellulose and hemicellulose are dissolved together, they can be separated from the lignin without the total hydrolysis of the dissolved polysaccharides.

In order to separate the majority of pentoses from hexoses, it is possible to employ the invention process in several ways. In the preferred embodiment it is possible to dissolve hemicellulose first and do a separate hydrolysis from cellulose. In another embodiment both hemicellulose and cellulose are dissolved and hydrolyzed, and the pentoses can be mostly separated from the hexoses by fractional precipitation. In another embodiment the hemicellulose and cellulose are dissolved and hydrolyzed in a condition such that most of the hemicellulose is hydrolyzed while the cellulose oligomers are still long enough to be precipitated upon addition of an anti-solvent, or by addition of water.

In one of the embodiments of the invention process the added acid can be removed after the hydrolysis, prior to the recovery of monosaccharides. Acids have an inhibition effect in the downstream reactions of the monosaccharides, and can interfere in the precipitation step of disaccharides, necessitating a higher amount of the anti-solvents. In prior art hydrolysis processes, separation of volatile acids such as hydrochloric acid is difficult, as it forms an azeotrope with water. Fortunately, the azeotrope is broken in molten salt hydrate solutions such as ZnCl₂ concentrated solution of the present invention, a hydrochloric acid can be easily separated by flashing, distillation, countercurrent or concurrent stripping. Temperatures as employed in hydrolysis are sufficient to provide a significant gas phase fugacity of hydrochloric acid and avoid degradation of the sugars. Other non-volatile acids such as sulfuric or phosphoric acid can be removed by chemical treatment, preferably forming insoluble compounds. Due to the additional chemical consumption cost in non-volatile acids, the volatile hydrochloric acid is the disclosure preferred acid.

It was also discovered that together with having less acid such as HCl, less water in the hydrolysate is preferable, less amount of anti-solvent is necessary to precipitate the saccharides, and therefore, advantageously, less anti-solvent has to be recovered. The usual known ways of removing volatile acids can also effect removal of part of the water present in the hydrolysate molten salt hydrate solution. Preferably at least 5% of the water present in the molten salt hydrate is removed, more preferably at least 20% of the water present in the molten salt hydrate is removed, the upper limit being the solubility limit of the salt.

Another reason for removing the acid prior to the precipitation is that certain anti-solvents, such as acetone can react with glucose under acidic conditions, forming for example diacetone glucose.

In a preferred embodiment the process of the invention comprises a hydrolysis step where an equilibrium hydrolysis composition is attained, followed by a recovery step of substantially all of the disaccharides and higher oligosaccharides by precipitation upon the addition of an anti-solvent.

In a still more preferred embodiment, the precipitation step is followed by a second precipitation step to also recover the monosaccharides. The second precipitation step can, for example, be effected by the addition of a larger amount of the same anti-solvent after recovery of the first (mainly dimers) precipitate.

In an alternate embodiment the second precipitation step is carried out with a second anti-solvent that is different from the first. Preferably the first anti-solvent is removed prior to the addition of the second anti-solvent. Alternately the first anti-solvent can be present to cooperate with the second anti-solvent. Preferably, the two anti-solvents are selected so they can be separated by flash vaporization or distillation. In some cases the two solvents become immiscible after they are removed from the molten salt hydrate medium, which greatly facilitates their separation. More preferably the boiling point of the anti-solvents is lower than the bubble point of the molten salt hydrate.

The anti-solvents should preferably keep most of the molten salt hydrate medium in solution. More preferably the anti-solvents can keep all the dissolution media in solution. In a particular embodiment of the invention, addition of the first anti-solvent can be stepwise, to first precipitate undesirable compounds that would otherwise accumulate in the molten salt hydrate medium, but not the dimers. The undesirable compounds can be separated upon precipitation. Subsequently more anti-solvent is added to precipitate the dimers.

Preferably no oligomers higher than dimers are present in the final hydrolysate, but if present will precipitate in the first anti-solvent precipitation step.

In a particular embodiment of the invention, all the dimers are recycled to the hydrolysis step. In another embodiment, instead of recycle, a second hydrolysis step can be used to hydrolyze the dimers to monosaccharides. In a further particular embodiment, the dimers can be one of the desired products, and recovered as such. In another particular embodiment, the dimers can be the main product, in which case any monosaccharides are recycled to the hydrolysis step, only disaccharides being recovered in the process. In a further particular embodiment, higher oligomers, dimers and monosaccharides are the main product, the process being used for biomass densification.

Ways of recovering and purifying the precipitated saccharides are known to those skilled in the art. The solids can be recovered by, for example, filtration, sedimentation, flotation, and centrifugal separations.

The solids can be physically separated from the main molten salt hydrate plus solvent medium, but some adsorbed solvent can remain present in the solids. Preferably one or more steps of washing the precipitates with anti-solvent are performed. More preferably, the main anti-solvent stream is used to wash the precipitate before it is fed to the precipitation step. More preferably, the main anti-solvent stream is separated in 2 or more portions, and each portion used in a precipitate washing step. The recovered anti-solvent is then used to precipitate the saccharides.

Even with the washing step a small amount of solvent can be present in the solids. The solvents can be further removed by contacting the precipitates with a gas or vapor to effect the drying of the solids, the solvent being preferably recovered by condensation. Ways of removing the remaining solvent are known to the skilled in the art, such as, but not limited to, drying and vacuum drying. In a further particular embodiment the saccharides can be redissolved in water and the remaining solvent separated. After dissolution of saccharides in water they can be further separated and purified by means known in the art, such as adsorption and chromatographic methods employed in the sugar industry.

In one particular invention embodiment, after the removal of the disaccharide, the mixture of the molten salt hydrate and monosaccharide(s) can be subjected to a hydrogenation step and more preferably a further dehydration step, yielding mainly anhydropolyols, preferably dianhydropolyols, more preferably isosorbide.

Preferred anti-solvents for the first step are, ketones having at least 4 carbon atoms; aldehydes; alkanenitriles, in particular acetonitrile; and ethers, in particular diethylether, dipropylether, MTBE, but also ethers of higher molecular weight.

The preferred anti-solvents for the second step are ethers and ketones. It was discovered that ethers fully precipitate most of the saccharides, including the monosaccharides, whereas with ketones it is possible to selectively precipitate all the disaccharides while leaving while leaving a major portion of the monosaccharides in solution.

The selectivity of the precipitation step can be fine-tuned by adding to the anti-solvent relatively minor amounts of either a solvent, such as a C1 to C6 alcohol; or of a powerful non-solvent, such as an alkane or an aromatic compound, such as toluene. For example, ethanol can be used to minimize the amount of monosaccharides that is co-precipitated with the disaccharides in the first precipitation step. Conversely, toluene can be used to obtain a more complete precipitation of the monosaccharides in the second precipitation step.

The amount of anti-solvent used in each precipitation step varies with the type of anti-solvent; the temperature of the solution; and the result to be accomplished (for example, whether selective precipitation of oligomers is desired in the first precipitation step, or full precipitation of all saccharides is the goal). In general the amount of anti-solvent in the first step ranges from 1:10 to 2:1 wt/wt in the first step, and from 1:1 to 10:1 in the second step.

Usually in the first precipitation step not only the dimers (and oligomers, if present) but some monomers also precipitate, and are sent back to the final hydrolysis step. This is advantageous as the concentration of the saccharides in the hydrolysate increases, less anti-solvent is needed to precipitate the saccharides, and it makes it possible to operate in a continuous fashion. It is also possible to use a first precipitation step in which only oligomers heavier than dimers are precipitated; a second precipitation step in which mainly disaccharides are precipitated; and a final precipitation step for the monosaccharides.

The increase of saccharides in the molten salt hydrate dissolution medium can theoretically also be accomplished by increasing the amount of cellulose and/or hemicellulose added to the molten salt hydrate medium. This is not desired, as viscosity increases significantly with the dissolution of non-hydrolyzed polysaccharides with its undesired effects—less accessibility of the hydronium ion to effect hydrolysis, higher pressure drops to flow the mixture, lower efficiency in lignin recovery, possibility of gelation of the solution. Moreover, increase of the biomass to dissolution and hydrolysis medium is also accomplished in the prior art by percolation of concentrated acids in lignocellulose in several steps, which has the disadvantage of longer hydrolysis times and increased degradation of saccharides. An additional disadvantage of this prior art approach is that it favors the formation of higher oligomers, at the expense of the formation of dimers.

In the present process the desired concentration increase effect is obtained by recycling the disaccharides and some of the monosaccharides, without the increased viscosity penalty of the larger polysaccharides.

Without wishing to be bound by theory, the present inventors believe that the dissolution of cellulose and hemicellulose and full hydrolysis and recovery is possible thanks to:

a) the hydrated molten salt ions interaction with the hydroxyl groups of the cellulose (and hemicellulose), resulting in a dissolved material, accessible to acid hydrolysis;
b) the equilibrium hydrolysis that is reached within the acidified molten salt hydrate medium with enough time, where the further dehydration of glucose does not lead to unrecoverable decomposition products, but to the dimer cellobiose, having 1,6-anhydroglucose as the probable intermediary compound (xylose from hemicellulose reacts in the same fashion);
c) in ratios of molten salt hydrate to saccharides higher than 12 wt/wt only a small amount of other oligomers bigger than dimers are observed in the equilibrium hydrolysate;
d) cellobiose (and higher oligomers) can be precipitated by addition of an anti-solvent;
e) the cellobiose and some precipitated glucose can be recycled to the hydrolysis step;
f) the increased amount of glucose in the equilibrium hydrolysate increases the precipitation upon addition of the anti-solvents, and therefore less amount of anti-solvents is necessary;
g) after the first anti-solvent recovery of cellobiose, glucose can be further separated from the molten salt hydrate medium by another anti-solvent step or other ways known in the art;
h) remaining saccharides in the molten salt hydrate medium, if not fully recovered in the precipitation or recovery steps can be recycled with minimal degradation, as they are stable at such temperatures;
i) anhydroglucose probably reacts back promptly to glucose (hydration), as glucose is precipitated from the acidic molten salt hydrate plus anti-solvent medium;
j) the combination of high acidity without the presence of a high amount of free halide ions (such as Cl⁻), accessibility of the hydronium ions to the polysaccharides, the reasonably low temperature (less than 100° C., preferably less than 80° C.) and fast hydrolysis results in no significant degradation of the saccharides (for example, no significant formation of 5-hydroxymethylfurfural from 1,6-anhydroglucose is detected).
k) the combination of the anti-solvent and the molten salt hydrate, being a less hydrated system, allows the complete precipitation of dimers and oligomers, with a non-complete precipitation of monomers.

Without limiting the present invention by an interpretation of the phenomena involved, apparently ZnCl₂ interacts more strongly with water and also with the anti-solvents of the present invention than with the saccharides, leaving the saccharides free to interact with each other and to precipitate.

The claimed recovery of disaccharide in the present invention is effected by the use of anti-solvents. Besides the preferred use of anti-solvents, separation of monosaccharides can also be effected using other ways known in the art. Monosaccharides can be separated by the addition of a solid complexing salt such as ZnO, CaO or BaO. Monosaccharides can also be separated by the crystallization of a complex of molten salt and monosaccharide complex such as ZnCl₂ and glucose complex known in the art. Monosaccharides can also be separated by extraction, electrodialysis or chromatographic methods.

It is important to stress that under purely aqueous conditions (solutions of hydrolysate) without a molten salt hydrate such as ZnCl₂, the addition of anti-solvents led to complete precipitation of disaccharides and oligosaccharides, and most of monosaccharides, whereas in the presence of molten salt hydrate less monosaccharides precipitated, allowing for a separation of monosaccharides and disaccharides.

### DESCRIPTION OF ILLUSTRATIVE EMBODIMENTS/EXAMPLES

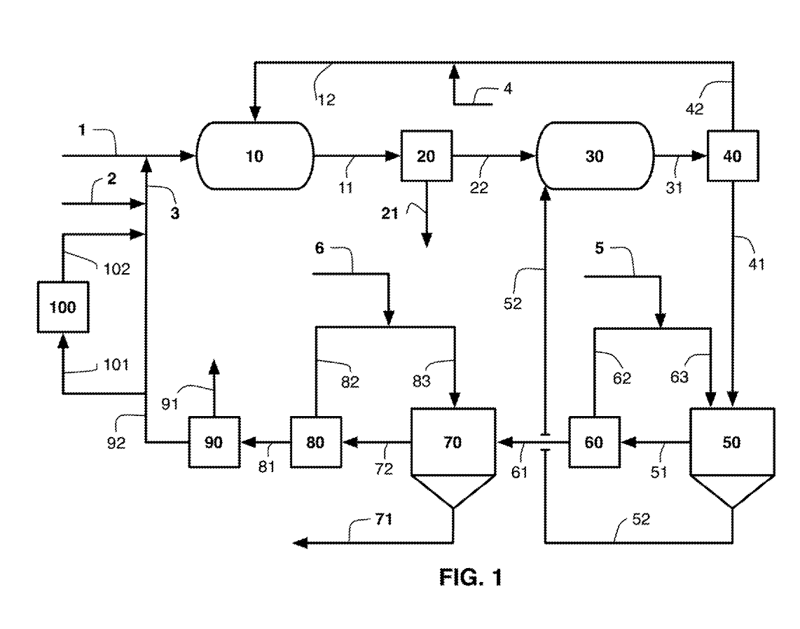

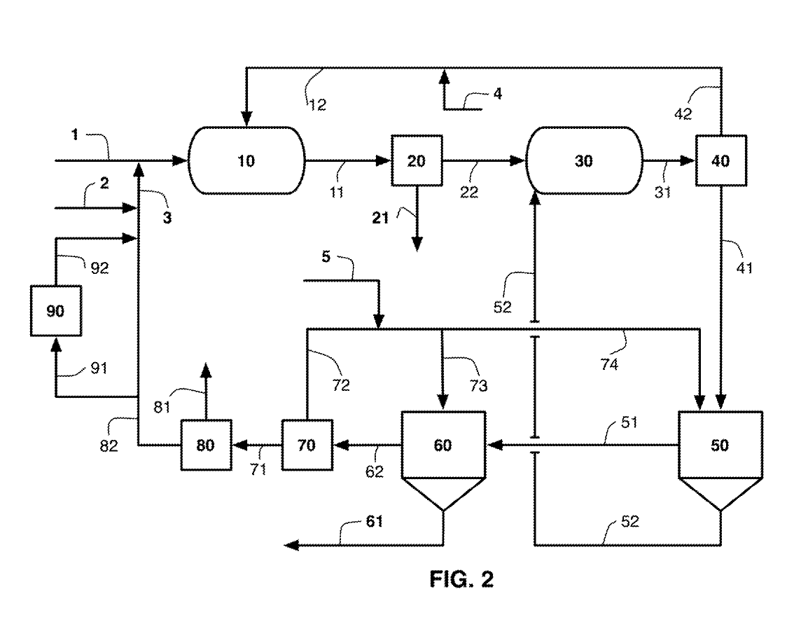

To illustrate the process of the invention two of the preferred embodiments are schematically presented in FIGS. 1 and 2. The invention encompasses but is not limited to the two disclosures, which are presented not to limit but to exemplify. Other process schemes including the invention step should be apparent to those skilled in the art.

FIG. 1 presents an embodiment of the process of the invention wherein two different anti-solvents are used for saccharides recovery.

Line 1 represents the flow of lignocellulosic biomass material. The lignocellulosic biomass material can comprise hemicellulose and cellulose and lignin—or just lignocellulose, where the hemicellulose portion was removed beforehand. This example represents the preferred embodiment, in which hemicellulose is removed first, so the biomass material consists primarily of cellulose and lignin. The lignocellulosic material (1) is mixed with the molten salt hydrate mixture (3) and sent together or separately to the reactor (10) to effect dissolution and, together with hydrochloric acid (12), effect the hydrolysis.

The hydrolysis carried out to a point where lignin and insolubles can be separated in separator (20).

The mixture of molten salt hydrate, dissolved polysaccharides and acid (11) are discharged from the hydrolysis reactor, and sent to the separation (20) of lignin (21). The lignin may be used elsewhere in the process. The polysaccharides in molten salt hydrate acidified medium (22) are mixed with the recycle stream (52), consisting mainly of cellobiose, and sent to the final hydrolysis reactor (30).

In the final hydrolysis reactor (30) a maximum equilibrium amount of glucose is attained in the equilibrium hydrolysate (31).

Hydrochloric acid (42) to be recycled to the hydrolysis step is removed from the main hydrolysate (31) in separator (40). Also a small make-up of hydrochloric acid may be necessary (4) to compensate for losses.

The mixture of molten salt hydrate and mainly glucose and cellobiose (41) is mixed with an anti-solvent stream (63) in the first precipitation and recovery step (50). The dimers stream (52) are recovered and sent back to the final hydrolysis step (30) while the molten salt hydrate plus glucose and anti-solvent mixture (51) is sent to the solvent recovery step (60). The anti-solvent is recovered (62) and mixed with an anti-solvent makeup (5) prior to the addition (63) to the precipitation step (50).

The stream of salt hydrate with glucose (61) is sent to the second precipitation step (70) where it is mixed with a second anti-solvent (83). A glucose stream is recovered (71) and the mixture of the solvent plus molten salt hydrate (72) sent to a second solvent recovery step (80). In the second solvent recovery step (80) the anti-solvent is recovered (82) and mixed with a solvent makeup prior to the reuse (83).

There is a consumption of water in the hydrolysis steps (10 and 30), but usually wet biomass is added in stream 1, containing more water than is needed in the process, so a water removal step (90) is necessary to recover excess water (91) and to keep the concentration of molten salt hydrate (92) within desired limits.

There might be also a regeneration of part (101) or all of the molten salt hydrate being effected at (100), from a portion of molten salt hydrate main flow (92), resulting in a regenerated molten salt hydrate (102), returning again to the main molten salt hydrate recycle (3). A small make-up (2) of molten salt hydrate might also be necessary.

The molten salt hydrate in the desired composition (3) is then continuously added to the lignocellulosic material (1), resulting in a whole continuous process.

In another embodiment of the present invention, presented in FIG. 2 the same anti-solvent is used to effect the recoveries of saccharides.

The line (1) represents the flux of lignocellulosic biomass material, comprising primarily cellulose and lignin in the described embodiment. The lignocellulosic material (1) is mixed with the molten salt hydrate mixture (3) and sent, together with hydrochloric acid (12), to the reactor (10) to effect dissolution and hydrolysis. The hydrolysis proceeds until lignin and insolubles can be separated in separator (20).

The mixture of molten salt hydrate, dissolved polysaccharides and acid (11) are discharged from the hydrolysis reactor, and sent to the separation (20) of lignin (21). The polysaccharides in molten salt hydrate acidified medium (22) are mixed with the recycle stream (52), consisting mainly of cellobiose, and sent to the final hydrolysis reactor (30).

In the final hydrolysis reactor (30) a maximum equilibrium amount of glucose is attained in the equilibrium hydrolysate (31).

In separator (40) hydrochloric acid (42), to be recycled to the hydrolysis step, is removed from the main hydrolysate (31). Also a small make-up of hydrochloric acid may be necessary (4) to compensate for losses.

The mixture of molten salt hydrate and mainly glucose and cellobiose (41) is mixed with an anti-solvent stream (74) in the first precipitation and recovery step (50). The dimers stream (52) are recovered and sent back to the final hydrolysis step (30) while the molten salt hydrate plus glucose and anti-solvent mixture (51) is sent to the second precipitation step (60).

The stream of salt hydrate with glucose (51) is sent to the second precipitation step (60) where it is mixed with additional anti-solvent (72). A glucose stream is recovered (61) and the mixture of the solvent plus molten salt hydrate (62) sent to the solvent recovery step (70). In the solvent recovery step (80) the anti-solvent is recovered (72) and mixed with a solvent makeup (5) prior to the reuse, and split in streams (73) and (74).

There is a consumption of water in the hydrolysis steps (10 and 30), but usually wet biomass with surplus water is added in stream 1 so a water removal step (80) is necessary to recover excess water (81) and keep the concentration of molten salt hydrate (82) constant.

There might be also a regeneration of part or totality of the molten salt hydrate being effected at (90), from a percentage of molten salt hydrate main flow (91), resulting in a regenerated molten salt hydrate (92), returning again to the main molten salt hydrate recycle (3). A small make-up (2) of molten salt hydrate might also be necessary. The molten salt hydrate in the desired composition (3) is then continuously added to the lignocellulosic material (1), resulting in a whole continuous process.

It should be apparent to those skilled in the art that variations in the process scheme are possible without departing from the scope of invention.

After the recovery of the saccharides the anti-solvent can be easily separated from the molten salt hydrate. Flash, distillation, and stripping, are preferred ways of recovering the anti-solvent. Depending on the nature of the anti-solvent, if it is an ether, or if it is a mixture with hydrocarbons, removal of part of the anti-solvent can render it insoluble with the molten salt hydrate, resulting in a simpler, less energy demanding separation.

Depending on the degree of treatment of the biomass previously to the hydrolysis step undesired compounds can accumulate in the molten salt hydrate media, such as degradation products. It may be necessary to treat a small part or the whole of the molten salt hydrate. Known ways of treatment are aqueous phase oxidation, hydrothermal treatment, crystallization, adsorption, membrane ultrafiltration, and among others extraction of the salt from the aqueous solution, known in the art in the hydrometallurgy field. Preferred way is the extraction of the salt.

In a particular embodiment, the temperature of the disaccharides recovery step is higher than the monosaccharides recovery step. In this way the selectivity for the removal of saccharides can be increased, by lowering the precipitation of monosaccharides in the first step and increasing the precipitation of monosaccharides in the last step.

In another particular embodiment, it was discovered that the disaccharides and oligosaccharides promptly precipitate whereas in the same solution monosaccharides take a longer time to precipitate. It is thus possible to design the equipments of contact between the hydrolysate and anti-solvent in order to separate mostly disaccharides and oligosaccharides in the first precipitation step, and the monosaccharides in the final precipitation step.

In a particular embodiment ZnCl₂ can be partially or totally separated from the hydrolysate before the anti-solvent precipitation of saccharides. It was discovered that ZnCl₂ can be selectively removed from the hydrolysate without the removal of the sugars in one of two main ways, either by extraction of ZnCl₂, for example with TBP (tributylphosphate) or an amine group containing extractant (such as Aliquat 336); or an ether such as di-isopropyl ether; or by complexation of ZnCl₂ with ammonia or pyridine with precipitation of the adduct formed. Surprisingly, it was discovered that it is possible to effect the separation of ZnCl₂ and keep all the saccharides in the remaining aqueous liquid phase, with no saccharides being transferred to the ZnCl₂ rich phase.

In such separations it is possible to fully recover ZnCl₂ by ways known in the art, such as the addition of compounds that complex strongly with the extractant (for example alcohols) that can be later vaporized, by vaporization of the extractant itself (in the case of ethers) or in the case of the ethers themselves. Also, adducts of ZnCl₂ with, for example ammonia or pyridine, can be broken with thermal treatment.

It is also noted that addition of amount of bigger ethers such as di-isopropyl ether can effect the separation of phases, an ether rich phase comprising a significant amount of extracted ZnCl₂, and a water-rich phase containing most or all the saccharides, and some ZnCl₂. Further addition of the ether will result in precipitation of saccharides and full solubilization of the ZnCl₂. It is also possible to vaporize some of the water between the ether extraction steps in order to use less ether in the next extraction step. Several extraction steps can be used, a first step to remove ZnCl₂ and a subsequent step to precipitate the saccharides. Some of the extraction steps can use different ethers or anti-solvent compounds in order to enhance the separation of the oligo-from the monosaccharides. Heavier ethers can be recovered by addition of water or by vaporization of the ether, or by addition of an alkane to make the solution less polar, addition of water being the preferred way, due to lower energy demand. Also different temperatures at different extraction steps can be used, as more ZnCl₂ and water will be extracted at higher temperatures, and two phases, a water plus ZnCl₂ phase and an ether phase, are formed upon cooling.

In a particular invention embodiment the molten salt hydrate ZnCl₂ and saccharides obtained from biomass hydrolysis are contacted with a heavier (6 or more carbon atoms) ether. Two phases are separated, an ether phase containing at least 25%, preferably at least 50% of the original ZnCl₂, and, as a second phase, an aqueous solution containing the saccharides, which can be further mixed with different anti-solvents in order to recover the oligosaccharides.

In a further particular embodiment, it is possible to combine the ZnCl₂ extractant with an anti-solvent for saccharides of the present invention, separating the saccharides as precipitates, and finally separating the anti-solvent from the ZnCl₂ plus extractant solution, lowering the total amount of anti-solvent needed.

### EXAMPLES

### Example 1

### Prior Art—Hydrolysis without ZnCl₂

Long fibers cellulose (from cotton lint) was mixed with four times its weight of HCl 36% and kept at 60° C. for 2 h. Only traces of glucose were found in the HPLC analysis of the liquid product.

This example shows that even in an acidic medium, at low temperature, without the dissolution effect observed in the molten salt hydrate, no significant hydrolysis occurs.

### Example 2

### Cellulose Hydrolysis to Hydrolysate

The same cellulose of example 1 was mixed to 12 times its weight of a 70% ZnCl₂ solution containing additional 0.4 molal of HCl and kept at 70° C. Samples of hydrolysate were diluted to precipitate cellulose and the liquid analyzed with a HPLC. After 60 minutes a composition of 75% glucose, 20% cellobiose (a glucose dimer) and less than 5% 1,6-anhydroglucose and oligomers was obtained. Analysis of the reaction products over time showed no change in composition, indicating that equilibrium had been reached.

This example shows that in the molten salt hydrate medium plus acid of the present invention there is a chemical equilibrium between the 3 species.

### Example 3

### Cellobiose Hydrolysis to Hydrolysate

Cellobiose was mixed with 12 times its weight of a 70% ZnCl₂ solution containing additional 0.4 molal of HCl and kept at 70° C. Samples of hydrolysate were diluted with water and the liquid analyzed with a HPLC. Within 30 minutes the composition equal to that example 2 was obtained.

This example shows that the same equilibrium attained in Example 2 is obtained when cellobiose instead of cellulose is used as the reactant.

### Example 4

### Anhydroglucose Conversion to Hydrolysate

1,6-Anhydroglucose (levoglucosan) was mixed with 12 times its weight of a 70% ZnCl₂ solution containing additional 0.4 molal of HCl and kept at 70° C. Samples of hydrolysate were diluted with water and the liquid analyzed with a HPLC. Within 15 minutes (the first sample) the invariant composition equal to the example 2 was obtained, as confirmed by samples taken later in the process. This example shows that the same equilibrium attained in Examples 2 and 3 is obtained having anhydroglucose as the reactant.

### Example 5

### Glucose Conversion to Hydrolysate

Glucose was mixed with 12 times its weight of a 70% ZnCl₂ solution containing additional 0.4 molal of HCl and kept at 70° C. for 30 minutes. The product was diluted with water and the liquid analyzed with a HPLC. The composition that was obtained was equal to that of example 2.

This example shows that the same equilibrium attained in Examples 2 and 3 and 4 is obtained having glucose as the reactant.

### Example 6

### Glucose Stability in Prior Art Hydrolysis Acid Solutions

Glucose was mixed with 12 times its weight of a 36% HCl solution and kept at 70° C. Samples were taken every 15 minutes. The product shows glucose being steadily converted to decomposition products, with no equilibrium being reached.

### Example 7

### Equilibrium Hydrolysate with Increased Saccharides Concentration

A mixture of equal amounts of glucose and cellobiose was mixed with 6 times its weight of a 70% ZnCl₂ solution containing additional 0.4 molal of HCl and kept at 70° C. Samples of hydrolysate were diluted to precipitate cellulose, and the liquid analyzed with a HPLC. Different from example 1, besides the presence of glucose and cellobiose, oligosaccharides where also detected. Analysis of the reaction products along time showed no change in composition over time, showing an equilibrium had been reached.

Increasing the concentration of saccharides, namely glucose, using ratios of 4 and 3 times its weight to the ZnCl₂ solution resulted in a further increased amount of oligomers in the product. Analysis of the reaction products over time showed no change in composition, indicating that an equilibrium had been reached.

The example shows that for ratios of saccharides to acidic molten salt hydrate higher than 1:12, significant, amounts of oligomers are also formed in the equilibrium.

### Example 8

### Xylan Plus Cellulose Hydrolysis

A mixture of ⅔ cellulose and ⅓ xylan was mixed with 12 times its weight of a 70% ZnCl₂ solution containing additional 0.2 molal of HCl and kept at 70° C. Samples of hydrolysate were diluted with water and the liquid was analyzed with a HPLC. Within 60 minutes no cellulose or xylan was detected; and only glucose, xylose, cellobiose, two other dimers and a small amount of anhydroglucose were detected.

### Example 9

### Glucose Plus Xylose Conversion Under Hydrolysis Conditions

A mixture of ⅔ glucose and ⅓ xylose was added to 12 times its weight of a 70% ZnCl₂ solution containing additional 0.2 molal of HCl and kept at 70° C. Samples of hydrolysate were diluted with water and the liquid analyzed with a HPLC. Within 60 minutes virtually the same composition of Example 8 was obtained.

### Example 10

### Hydrolysis Real Biomass (Bagasse) with 30% ZnCl₂

Dry sugarcane bagasse was mixed at 60° C. with 12 times its weight of a 30% ZnCl₂ solution. The liquid solution was separated from the remaining solid bagasse. The weight loss of the bagasse was equal to the hemicellulose amount (27%).

This example shows that it is possible to remove hemicellulose from the biomass by using a more dilute ZnCl₂ solution that is not capable of dissolving cellulose.

### Example 11

### Hydrolysis of Xylan Obtained from Bagasse

The liquid solution containing hemicellulose dissolved in 30% ZnCl₂ from Example 10 was further acidified until 0.2 molal of HCl and hydrolyzed for 1 h. HPLC analysis of hydrolysate showed xylose as the main hydrolysis product.

This and the previous example show that in a preferred embodiment of the reaction it is possible to separate and hydrolyze hemicellulose from cellulose by using a more dilute ZnCl₂ solution that is not capable of dissolving cellulose.

### Example 12

### Hydrolysis Real Biomass (Bagasse) with 70% ZnCl₂ Plus Acid

Sugarcane bagasse was mixed at 60° C. with 12 times its weight of a 70% ZnCl₂ solution containing additional 0.2 molal of HCl. After 2 h hydrolysis time just lignin remained solid, and HPLC showed C6 and C5 saccharides and dimers as hydrolysis products.

### Example 13

### Precipitation of Hydrolysate with 2-Butanone

The hydrolysate obtained in Example 2 was mixed with different amounts of 2-butanone. With 2.33 parts of 2-butanone to 1 part (mass) of hydrolysate, 91% of the cellobiose precipitated, and only 45.6% of the glucose precipitated.

The final precipitate was dried to remove the solvent, redissolved in water and analyzed in the HPLC. Only the cellobiose and glucose peaks appeared. No other oligomers were detected in the equilibrium hydrolysate. The 1,6-anhydroglucose was not detected either, and probably, if formed, it was promptly converted to glucose in the acidic conditions by the shift of equilibrium, as glucose was being precipitated by the addition of the anti-solvent.

### Example 14

### Precipitation of Hydrolysate with Acetonitrile

One part of the hydrolysate obtained in Example 2 was mixed with different amounts of acetonitrile. With 4 parts of acetonitrile all cellobiose precipitated, and only 38% of the glucose precipitated.

### Example 15

### Precipitation of Hydrolysate with Ethers—MTBE, DEE

The hydrolysate obtained in Example 2 was mixed with different amounts of Methyl tert-butyl ether (MTBE) and diethyl ether (DEE).

With 1.5 parts of diethyl ether 100% of cellobiose and 95.5% of the glucose precipitated. With 0.67 parts of Methyl tert-butyl ether (MTBE) 100% of the cellobiose and 94.6% of glucose precipitated.

With amounts of MTBE and DEE lower than described above, two liquid phases were formed, a solvent-poor, sugar rich phase, and a higher solvent phase containing ZnCl₂ and some water, without precipitates in either phase.

### Example 16

### Mix of 2-Butanone with Toluene and MTBE

To the mixture obtained from Example 2, 0.1 parts of toluene per part of 2-butanone were added, causing all the cellobiose to precipitate (with only a small increase in precipitation of glucose). The same happened with 0.1 parts of MTBE.

### Example 17

### Addition of Alcohols to Precipitate

To the cellulose hydrolysate obtained in Example 2, ethanol and isopropanol alcohols were added. The precipitation of disaccharides was observed.

### Example 18

### Mix of Xylose, Glucose and Dimers Mixture with 2-Butanone-Unprecipitated Xylose

To the cellulose and hemicellulose (xylan) hydrolysate obtained in Example 8, different amounts of 2-butanone were added. With 9 parts of 2-butanone per part of hydrolysate all cellobiose and the other dimers precipitated, 75% of glucose precipitated but only 10% of xylose precipitated.

### Example 19

### Adding Ethers to Precipitate Xylose

To the mixture obtained in Example 18, diethyl ether was added, causing all the remaining xylose to precipitate.

This example shows that it is possible to recover separately the glucose, dimers and xylose from the hydrolysate.

### Example 20

### Extraction of ZnCl₂ from the Equilibrium Hydrolysate with Tributyl Phosphate (TBP)

3.0733 g of the equilibrium hydrolysate of Example 2 (aqueous phase) were placed in contact with 7.68 g of TBP (organic phase) at room temperature in order to have a molar ratio between TBP and ZnCl₂ of 2 mol/mol. The mixture was stirred vigorously during 1 h to induce good contact between the phases. The mixture was centrifuged to induce phase separation. After the phase contact, the ZnCl₂ concentration in the hydrolysate dropped to 32% in weight, while the carbohydrates remained in the aqueous phase. This represents a ZnCl₂ extraction efficiency of 73%.

Additional contact steps with TBP further lowered the amount of ZnCl₂ in the aqueous phase, without extracting any saccharide.

This example shows that it is possible to recover at least part of ZnCl₂, without removal of glucose or cellobiose from the hydrolysate.

### Example 21

### Recovery of ZnCl₂ from the Equilibrium Hydrolysate by Complexation with Ammonia

1.8544 g of the equilibrium hydrolysate of Example 2 were added while stirring to 6.85 g of an NH3/methanol containing 2 mol NH3 per liter of solution at room temperature. A white precipitate was immediately formed. After settling for 15 min, the precipitate sedimented to the bottom of the flask and the supernatant liquid showed a tremendous decrease in the ZnCl₂ concentration. 96% of the initial ZnCl₂ was precipitated as a complex while the carbohydrates remained in the aqueous solution.

This example shows that it is possible to recover ZnCl₂, without removal of glucose or cellobiose from the hydrolysate.

### Example 22

### Combination of TBP Extraction of ZnCl₂ with Anti-Solvent Precipitation

1.1939 g of the equilibrium hydrolysate (aqueous phase) obtained in Example 2 were placed in contact with a mixture containing 1.1939 g of TBP and 0.8084 g acetone (organic phase) at room temperature. The molar ratio between TBP and ZnCl₂ was 0.8 mol/mol. The mixture was stirred vigorously during 15 min creating good contact between the phases. The mixture was centrifuged to induce phase separation. After the phase contact, 72% of the ZnCl₂ was extracted from the hydrolysate, while the carbohydrates remained in the aqueous phase.

When acetone is not present, with the same TBP/ZnCl₂ molar ratio of 0.8, only 46% of the ZnCl₂ was extracted from the hydrolysate.

Unexpectedly, the mixture of the anti-solvent plus the ZnCl₂ extractant (TBP), yield a better extraction of ZnCl₂ phase.

This example shows that an increased removal of ZnCl₂ with lower amount of ZnCl₂ extractant can be attained by the combination of TBP with an antisolvent.

### Example 23

### Combination of TBP Extraction of ZnCl₂ with Higher Amounts of Anti-Solvent Precipitation

### 23a. Precipitation of Mixture of Glucose and Cellobiose with Acetone

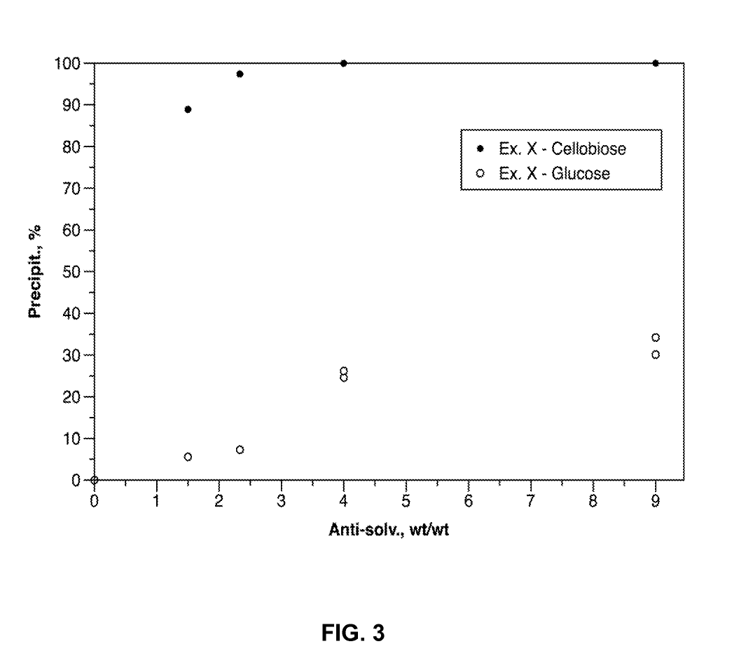

To an amount of equal weight glucose and cellobiose 12 times of a 70% ZnCl₂ solution was added. The mixture was stirred to dissolve all the sugars and kept at ambient temperature (circa 22° C.). No change in composition (hydrolysis of cellobiose) was observed in HPLC. Portions of acetone were added to the mixture and the amount of precipitated saccharides were analyzed by HPLC of the liquid phase. None of the ZnCl₂ precipitated. The percentage of cellobiose and glucose precipitated are shown in FIG. 3.

### 23b

1.0865 g of equilibrium hydrolysate obtained in Example 2 were added while stirring to a mixture containing 1.8221 g of TBP and 3.7313 of acetone. The solution formed one homogeneous phase and a precipitate was observed. The TBP was loaded with 15% of the original ZnCl₂ present in the hydrolysate. All the cellobiose and 80% of the glucose were precipitated.

The combination of ZnCl₂ extractant and the anti-solvent resulted in increased recovery of saccharides compared to using the anti-solvent alone. This results in less energy being needed to recover the anti-solvent.

This example shows that an increased recovery of saccharides can be attained by the combination with lower amounts of ZnCl₂ extractant and a saccharide anti-solvent.

### Example 24

### Different Precipitation Times

The remaining samples of Examples 23a. and 13 were left to rest from 2 hours to 2 days after the first precipitation. More glucose precipitated from the remaining solutions over time.

This example shows that the disaccharides and heavier precipitate promptly, whereas the monosaccharides precipitate more slowly. It is possible, with long enough time in a batch process, to recover most of monosaccharides without further addition of anti-solvent. Conversely, it is possible to obtain a more selective precipitation of disaccharides by using short precipitation times.

### Example 25

### Different Temperatures in Each Recovery Step

The remaining samples of Example 23a. after the recovery of cellobiose, with most of glucose still dissolved in the mixture of ZnCl₂ and acetone at ambient temperature (circa 22° C.), were cooled to −10° C. The remaining glucose precipitated as the temperature decreased.

This example shows that a higher temperature in the disaccharides (and oligomers) recovery step than in the final monosaccharides recovery step can lead to a more selective process.

### Example 26

### Extraction of Zinc Chloride

13.6 g of H₂O, 2.14 g of 36% w HCl in water, 34.75 g of ZnCl₂ and 3.43 g of glucose were mixed and stirred for 30 minutes at room temperature to form a clear solution. 1.50 g of this solution was transferred to 10 ml vial. To this vial 4.626 g of di-isopropyl ether (DIPE) was added. Two phases were present in the vial: at the top the ether phase, at the bottom the aqueous phase. The vial was shaken vigorously for 1 minute after which the liquid was allowed to settle for 30 minutes. After settling, still two phases were present, but the aqueous phase was significantly reduced in volume. The initial and final mass fractions of the aqueous and ether phase were determined using HPLC and are shown in Table 1. Note that the ZnCl₂ and HCl amounts are shown as a combined amount because they appeared as a single peak in the HPLC chromatogram.

After the extraction experiment 0.985 g of the loaded ether phase was transferred to a clean 10 ml vial. To this loaded ether phase 0.26 g of water was added. Immediately two phases were formed: an ether phase at the top and an aqueous phase at the bottom. This mixture was shaken for 1 minute and then left to settle for 30 minutes. Again the initial and final mass fractions of the aqueous and ether phase were determined using HPLC, and are shown in Table 2.

From the mass balance it was estimated that about 51.5% w of ZnCl₂ was transferred to the ether phase, together with 14.6% w of the water. Although glucose could not be found in the ether phase by HPLC analysis, from the back-extraction experiment it was determined that about 2% w of glucose was transferred to the ether phase. The loss of DIPE to the aqueous phase was estimated to be only 0.25% w. Back-extraction of ZnCl₂ with water was found to be very efficient: already with a water to loaded-ether ratio of 1:3.8 more than 99.9% w of the ZnCl₂ and HCl was back-extracted. This led to a ZnCl₂ solution of 23.3% w. With a lower water to loaded-ether ratio much more concentrated solutions can be obtained.

TABLE 1
ZnCl₂ extraction results with di-isopropyl ether at 298 K.

| Fractions | Aq. Initial | Aq. Final | Ether Initial | Ether Final |
|---|---|---|---|---|
| ZnCl₂ + HCl | 0.66 | 0.54 | 0 | 0.10 |
| Glucose | 0.064 | 0.107 | 0 | 0 |
| Water | 0.27 | 0.35 | 0 | 0.012 |
| DIPE | 0 | 0.012 | 1 | 0.089 |

TABLE 2
Water back extraction results.

| Fractions | Aq. Initial | Aq. Final | Ether Initial | Ether Final |
|---|---|---|---|---|
| ZnCl₂ + HCl | 0 | 0.233 | 0.10 | 0.002 |
| Glucose | 0 | 0.0013 | 0 | 0 |
| Water | 1 | 0.763 | 0.012 | 0.01 |
| DIPE | 0 | 0.003 | 0.089 | 0.988 |

This example shows that DIPE is a very efficient extractant to remove ZnCl₂ at high ZnCl₂ concentrations. It has a very high ZnCl₂ to glucose selectivity and it can be very efficiently back-extracted by simple water addition.

Thus, the invention has been described by reference to certain embodiments discussed above. It will be recognized that these embodiments are susceptible to various modifications and alternative forms well known to those of skill in the art.

Many modifications in addition to those described above may be made to the solvents and techniques described herein without departing from the spirit and scope of the invention. Accordingly, although specific embodiments have been described, these are examples only and are not limiting upon the scope of the invention.

1. A method for isolating monosaccharides and/or saccharide oligomers from a solution further comprising water and a molten salt hydrate, said method comprising the step of adding to the solution an effective amount of an anti-solvent selected from the group consisting of ketones having four or more carbon atoms; ethers; alkanenitriles; and mixtures thereof, thereby precipitating at least the saccharide oligomers from the solution.

2. The method of claim 1 wherein the saccharide oligomers are precipitated from the solution upon addition of the anti-solvent, and the monosaccharides remain at least partially in solution.

3. The method of claim 1 wherein both the saccharide oligomers and the monosaccharides are precipitated from the solution upon addition of the anti-solvent.

4. The use of the method of claim 3 in a biomass densification process.

5. The method of claim 2 wherein the solubility of the monosaccharides in the solution is increased by mixing the anti-solvent with an alkanol prior to addition to the solution.

6. The method of claim 5 wherein the alkanol is methanol, ethanol, or a mixture thereof.

7. The method of claim 3 wherein the solubility of the monosaccharides in the solution is decreased by further adding to the solution an alkane or an aromatic compound.

8. The method of claim 2 wherein the precipitated oligomers are separated from the solution within 15 minutes after addition of the anti-solvent to the solution.

9. The method of claim 1 wherein the addition of the anti-solvent is preceded by an extraction of the molten salt hydrate with a selective extractant.

10. The method of claim 9 wherein the extractant is a trialkyl phosphate, in particular tributyl phosphate (TBP).

11. The method of claim 1 wherein the solution comprising saccharide oligomers, monosaccharides, water, and molten salt hydrate is prepared by dissolving a cellulose-containing material in the molten salt hydrate, and hydrolyzing dissolved cellulose to form saccharide oligomers and monosaccharides.

12. The process of claim 11 wherein isolated saccharide oligomers are recycled to the cellulose hydrolysis step.

13. The process of claim 11 wherein isolated monosaccharides are recycled to the cellulose hydrolysis step.
